(19) United States
(12) Patent Application Publication
(10) Pub. No.: US 2025/0009584 A1
(43) Pub. Date: Jan. 9, 2025

(54) EXAMINATION TABLE DEVICE, MEDICAL IMAGE CAPTURING SYSTEM, AND OPERATION METHOD OF EXAMINATION TABLE DEVICE

(71) Applicant: FUJIFILM Healthcare Corporation, Chiba (JP)

(72) Inventors: Satoshi IIZUKA, Chiba (JP); Hirokazu HONMA, Chiba (JP)

(73) Assignee: FUJIFILM Healthcare Corporation, Chiba (JP)

(21) Appl. No.: 18/752,768

(22) Filed: Jun. 24, 2024

(30) Foreign Application Priority Data
Jul. 4, 2023 (JP) 2023-110248

(51) Int. Cl. A61G 13/00; A61G 13/10; G06T 1/00

(52) U.S. Cl. CPC A61G 13/0018; A61G 13/104; G06T 1/0007

(57) ABSTRACT

With an examination table device according to an aspect of the present invention, locking of a traveling unit and locking of a top plate are automatically (independently of an operation of a user) are performed in conjunction with connection between the examination table device and a medical image capturing apparatus, so that it is not necessary for the user to perform operations for the locking of the traveling unit and the locking of the top plate in a case of the connection and the connection release. In addition, there is no concern that the traveling unit is not locked due to operation forgetting, the locking release of the top plate is not in time for an operation timing, or the like. Therefore, the locking states of the traveling unit and the top plate can be reliably controlled.

### CROSS-REFERENCE TO RELATED APPLICATION

The present application claims priority under 35 U.S.C § 119(a) to Japanese Patent Application No. 2023-110248 filed on Jul. 4, 2023, which is hereby expressly incorporated by reference, in its entirety, into the present application.

### BACKGROUND OF THE INVENTION

### 1. Field of the Invention

The present invention relates to an examination table device that can be connected to a medical image capturing apparatus, a medical image capturing system including an examination table device, and an operation method of an examination table device, and particularly, to a technique of controlling connection and locking of the examination table device.

### 2. Description of the Related Art

In a case of capturing a medical image of a subject with a medical image capturing apparatus (or a medical image diagnostic apparatus) such as a magnetic resonance imaging apparatus (MRI) or an X-ray computed tomography (CT) apparatus, it is known to use an examination table device attachable to and detachable from a body of the medical image capturing apparatus from the viewpoint of reducing the time and effort required to transfer the subject in a case of moving from a sickroom in which the subject exists to an examination room in which the medical image capturing apparatus is installed, or from the viewpoint of restricting the use of a magnetic material in the examination room (see, for example, JP7197984B). JP7197984B discloses the examination table device that can be mechanically and electrically connected to the body of the medical image capturing apparatus.

In a case in which such an examination table device is used, an operation of connecting (docking) the examination table device to the medical image capturing apparatus and an operation of releasing the connection are required, and an operation of locking a traveling unit of the examination table device and an operation of releasing the locking are required. In JP7197984B, a coupling pedal for mechanically connecting the examination table device and the MRI apparatus, and a caster locking pedal for locking a caster provided on the traveling unit of the examination table device are provided, and in a case in which the caster locking pedal is operated, the caster is locked, and the examination table device and the MRI apparatus are electrically connected to each other.

### SUMMARY OF THE INVENTION

After the examination table device is connected to the body of the medical image diagnostic apparatus, it is necessary to lock the caster of the examination table device such that the examination table does not move and unintended damage does not occur in a case in which the subject moves. However, in a case in which the pedal for locking the caster is operated as in JP7197984B, there is a possibility that the caster is not locked because a user forgets to operate the pedal.

In addition, there is the examination table device including a slidable top plate for moving the subject in an imaging space of the medical image capturing apparatus. In a case in which such an examination table device is used, it is necessary to lock the top plate such that unintentional movement of the top plate and the damage of the examination table device or falling of the subject do not occur during the transport of the examination table before being connected to the medical image capturing apparatus. Meanwhile, after the connection to the medical image capturing apparatus, it is necessary to release the locking such that the top plate can be slid. In order to perform such locking and the locking release, in the related art, a method has been adopted in which a locking pin is mechanically popped out or accommodated in conjunction with the start of the operation of the top plate. However, in such a method, the pin may not be able to pop out or be accommodated in time for the timing of the top plate operation due to assembly errors, temporal wear, or the like, and as a result, there is a possibility that the top plate may cannot be operated.

As described above, in the related art, the locking states of the traveling unit and the top plate cannot be reliably controlled.

The present invention has been made in view of such circumstances, and an object of the present invention is to provide an examination table device that can reliably control locking states of a traveling unit and a top plate, a medical image capturing system comprising the examination table device, and an operation method of an examination table device.

In order to achieve the above-described object, a first aspect of the present invention provides an examination table device comprising: a body part including a top plate on which a subject is placed; a traveling unit that causes the body part to travel; a connection connector unit that mechanically and electrically connects the body part to a medical image capturing apparatus configured separately from the body part, in an attachable and detachable manner; a connection operation member that receives operations of giving instructions to perform the connection and a release of the connection; a connection detection unit that detects presence or absence of the connection; and a controller that controls a locking state of the top plate and a travelable state of the traveling unit based on the detected presence or absence of the connection, in which the controller locks the traveling unit to make the body part unable to travel and releases locking of the top plate to make the top plate slidable in response to the detection of the connection via the connection detection unit, and releases the locking of the traveling unit to make the body part travelable and locks the top plate to make the top plate unable to slide in response to the detection of the release of the connection via the connection detection unit.

According to the first aspect, in a case in which the examination table device is connected to the medical image capturing apparatus, the detection unit detects the connection, and the controller locks the traveling unit and releases the locking of the top plate to make the top plate slidable, and in a case in which the connection between the examination table device and the medical image capturing apparatus is released, the detection unit detects the release of the connection, and the controller releases the locking of the traveling unit to make the examination table device travelable and locks the top plate to make the top plate unable to slide. That is, the locking of the traveling unit and the locking of the top plate are automatically (independently of the operation of the user) performed in conjunction with the connection between the examination table device and the medical image capturing apparatus, so that it is not necessary for the user to perform the operations for the locking of the traveling unit and the locking of the top plate in a case of the connection and the connection release. In addition, there is no concern that the traveling unit is not locked due to operation forgetting, the locking release of the top plate is not in time for an operation timing, or the like. As described above, according to the first aspect, the locking states of the traveling unit and the top plate can be reliably controlled.

The examination table device according to the first aspect can be applied to, for example, an MRI apparatus, but can also be applied to a medical image capturing apparatus (medical image diagnostic apparatus) such as an X-ray CT apparatus or a positron emission tomography (PET) apparatus with a movable examination table.

A second aspect provides the examination table device according to the first aspect, in which the traveling unit includes a caster that is lockable via electric power, and the controller locks the caster via the electric power to make the body part unable to travel, and releases the locking to make the body part travelable. The second aspect defines one aspect of the configuration of the traveling unit and the locking. It should be noted that, in the second aspect, it is preferable that the controller locks both the revolution and the rotation of a wheel of the caster. In addition, it is preferable that the controller performs the locking for all the wheels of the caster.

A third aspect provides the examination table device according to the first or second aspect, in which the traveling unit includes a stopper that is able to protrude toward a traveling surface from the body part, and the controller locks the traveling unit by causing the stopper to protrude and abut on the traveling surface, and releases the locking of the traveling unit by separating the stopper from the traveling surface. The third aspect defines another aspect of the configuration of the traveling unit and the locking. It should be noted that, in the third aspect, the number of the stoppers may be one or plural.

A fourth aspect provides the examination table device according to the third aspect, in which the traveling unit includes a first solenoid coil, a first spring member that is compressed by energizing the first solenoid coil, and the stopper connected to the first spring member, and the controller separates the stopper from the traveling surface by energizing the first solenoid coil to compress the first spring member, and causes the stopper to protrude and abut on the traveling surface by stopping energizing the first solenoid coil to stop compressing the first spring member. The fourth aspect defines one aspect of the configuration of the stopper.

A fifth aspect provides the examination table device according to any one of the first to fourth aspects, in which the body part includes a second solenoid coil, a second spring member that is compressed by energizing the second solenoid coil, and a locking pin connected to the second spring member, and the controller removes the locking pin from the top plate by energizing the second solenoid coil to compress the second spring member, and causes the locking pin to protrude and inserts the locking pin into the top plate by stopping energizing the second solenoid coil to stop compressing the second spring member. The fifth aspect defines one aspect of the configuration for locking the top plate.

A sixth aspect provides the examination table device according to any one of the first to fifth aspects, in which the body part includes a third solenoid coil and a magnetic material disposed on the top plate to face the third solenoid coil, and the controller makes the top plate unable to slide by energizing the third solenoid coil to attract the magnetic material on a side of the third solenoid coil, and makes the top plate slidable by stopping energizing the third solenoid coil to release the attraction. The sixth aspect defines another aspect of the configuration for locking the top plate.

A seventh aspect provides the examination table device according to any one of the first to sixth aspects, in which the connection operation member includes a connection pedal that receives an operation for the connection, and a connection release pedal that receives an operation for the release of the connection. The user can operate these pedals (for example, press the pedals with the foot) to perform the operation for the connection and the operation for the release of the connection.

An eighth aspect provides the examination table device according to any one of the first to seventh aspects, further comprising: a panel that displays one or more of a state of the connection, a locking state of the traveling unit, or the locking state of the top plate. According to the eighth aspect, the user can easily recognize the state of the connection or the locking state by the display.

A ninth aspect provides the examination table device according to the eighth aspect, in which the panel includes a locking operation member that receives a locking operation of giving an instruction to lock the traveling unit in a case in which the examination table device is not connected to the medical image capturing apparatus, and a locking release operation of giving an instruction to release the locking via the locking operation, and the controller locks the traveling unit in response to the locking operation, and releases the locking of the traveling unit in response to the locking release operation. According to the ninth aspect, the user can operate the panel to perform the operations for the locking of the traveling unit and the locking release as necessary in a case in which the examination table device is not connected to the medical image capturing apparatus (for example, during movement from the sickroom to the examination room).

In order to achieve the above-described object, a tenth aspect of the present invention provides a medical image capturing system comprising: the examination table device according to any one of the first to ninth aspects; and the medical image capturing apparatus. Since the medical image capturing system according to the tenth aspect comprises the examination table device according to any one of the first to ninth aspects, the locking states of the traveling unit and the top plate can be reliably controlled.

An eleventh aspect provides the medical image capturing system according to the tenth aspect, in which the medical image capturing apparatus includes any one of an MRI apparatus, an X-ray CT apparatus, or a PET apparatus. The eleventh aspect defines the aspect of the medical image capturing apparatus in a specific manner.

In order to achieve the above-described object, a twelfth aspect of the present invention provides an operation method of an examination table device including a body part including a top plate on which a subject is placed, a traveling unit that causes the body part to travel, a connection connector unit that mechanically and electrically connects the body part to a medical image capturing apparatus configured separately from the body part, in an attachable and detachable manner, a connection operation member that receives operations of giving instructions to perform the connection and a release of the connection, a connection detection unit that detects presence or absence of the connection, and a controller that controls a locking state of the top plate and a travelable state of the traveling unit based on the detected presence or absence of the connection, the operation method comprising: via the controller, locking the traveling unit to make the body part unable to travel and releasing locking of the top plate to make the top plate slidable in response to the detection of the connection via the connection detection unit; and releasing the locking of the traveling unit to make the body part travelable and locking the top plate to make the top plate unable to slide in response to the detection of the release of the connection via the connection detection unit. According to the twelfth aspect, the locking states of the traveling unit and the top plate can be reliably controlled, as in the first aspect.

As described above, with the examination table device, the medical image capturing system, and the operation method of the examination table device according to the aspects of the present invention, the locking states of the traveling unit and the top plate can be reliably controlled.

### BRIEF DESCRIPTION OF THE DRAWINGS

FIGS. 1A and 1B are views showing a configuration of a medical image capturing system.

FIG. 2 is a view showing a configuration of a medical image capturing apparatus.

FIG. 3 is a view showing a main configuration of an examination table device.

FIG. 4 is a view (1/2) showing work of a user and an operation of the system.

FIG. 5 is a view (2/2) showing the work of the user and the operation of the system.

FIG. 6 is a perspective view of a docking unit.

FIG. 7 is a perspective view of a pedal unit.

FIG. 8 is a view showing an example of an operation panel.

FIGS. 9A and 9B are views showing a state of mechanical connection between an examination table and an apparatus body.

FIGS. 10A and 10B are views showing a configuration of a top plate locking mechanism.

FIGS. 11A and 11B are top views showing a state in which locking/locking release of the top plate is performed by the top plate locking mechanism.

FIGS. 12A and 12B are partial cross-sectional views showing a state in which the locking/locking release of the top plate is performed by the top plate locking mechanism.

FIGS. 13A and 13B are views showing a modification example of a configuration of locking a traveling unit.

FIG. 14 is a view showing a modification example of the top plate locking mechanism.

### DESCRIPTION OF THE PREFERRED EMBODIMENTS

Hereinafter, preferred embodiments of an examination table device, a medical image capturing system, and an operation method of an examination table device according to an embodiment of the present invention will be described with reference to the accompanying drawings. It should be noted that, in the accompanying drawings, some components are not shown for convenience of description in some cases. In addition, the accompanying drawings do not show accurate shapes and dimensions of the examination table device, a medical image capturing apparatus, and the medical image capturing system.

### First Embodiment

### Overview of Medical Image Capturing System

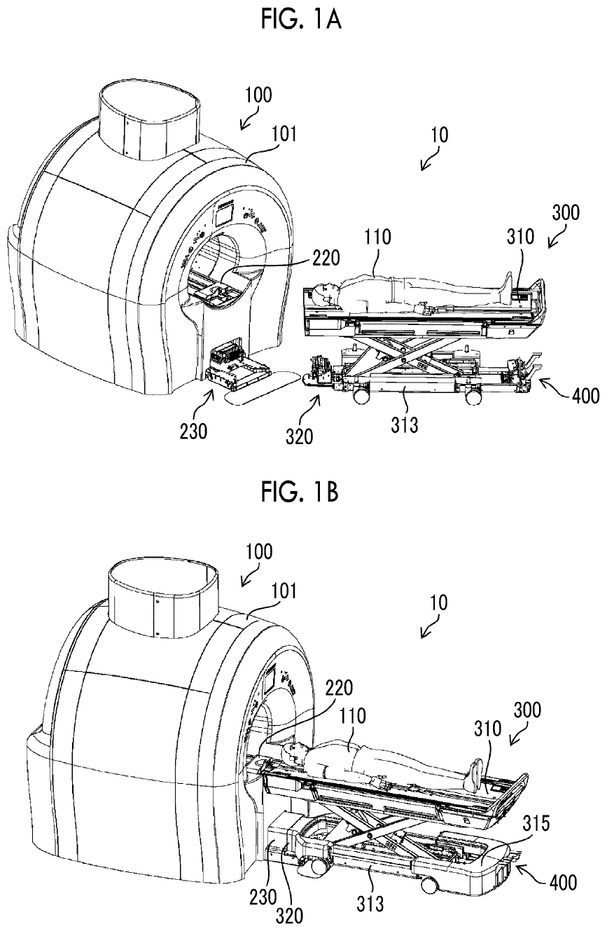

First, a configuration of a medical image capturing system will be described. As shown in FIGS. 1A and 1B, a medical image capturing system 10 according to a first embodiment comprises a medical image capturing apparatus 100 and an examination table device 300. FIG. 1A shows a state in which the medical image capturing apparatus 100 and the examination table device 300 are separated from each other, and FIG. 1B shows a state in which the medical image capturing apparatus 100 and the examination table device 300 are connected to each other.

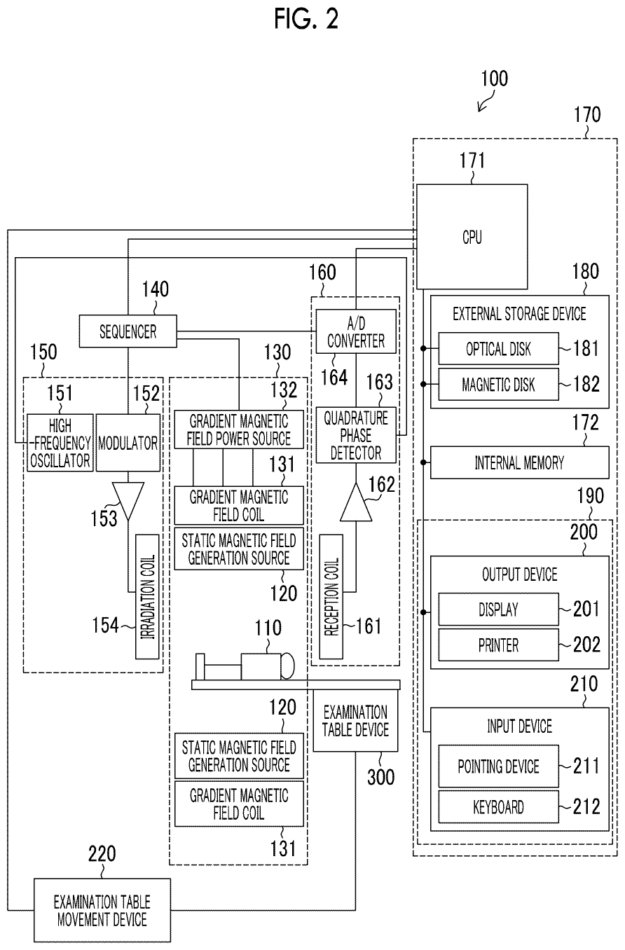

The medical image capturing apparatus 100 and an apparatus body 101 are apparatuses that obtain a tomographic image of a subject 110, and may have any configuration as long as an image of the subject 110 placed on the examination table device 300 can be captured. For example, an apparatus, such as a magnetic resonance imaging (MRI) apparatus using a nuclear magnetic resonance (NMR) phenomenon or an X-ray CT apparatus, can be used. In FIGS. 1A and 1B, as an example of the medical image capturing apparatus 100 and the apparatus body 101, a tunnel bore type MRI apparatus comprising a cylindrical gantry is shown. The apparatus body 101 has a cylindrical tunnel of which an axial direction is horizontal, and generates a static magnetic field in the tunnel to form an imaging space. The apparatus body 101 is disposed in an electromagnetically shielded room, and the gradient magnetic field power source 132, the sequencer 140, a high-frequency oscillator 151, a modulator 152, a high-frequency amplifier 153, a signal amplifier 162, a quadrature phase detector 163, an A/D converter 164, a controller 170, and the like (see FIG. 2) are disposed outside the electromagnetically shielded room and are electrically connected to the apparatus body 101 through a cable.

In addition, as described above with reference to FIGS. 1A and 1B, in the medical image capturing system 10, the examination table device 300 on which the subject 110 is placed can be connected to and separated (connection can be released) from the medical image capturing apparatus 100 for imaging the subject 110, and a pedal unit 400 for operating the connection of the examination table device 300 is provided in the examination table device 300. Details of the examination table device 300, the connection structure between the examination table device 300 and the medical image capturing apparatus 100, and control of a locking state will be described in detail below.

### Configuration of Medical Image Capturing Apparatus

FIG. 2 is a view showing a configuration of the medical image capturing apparatus 100. As shown in FIG. 2, the medical image capturing apparatus 100 comprises a static magnetic field generation source 120, a gradient magnetic field generation unit 130, a sequencer 140, a high-frequency irradiation unit 150, a signal detection unit 160, and a controller 170.

The static magnetic field generation source 120 generates a uniform static magnetic field in a static magnetic field space accommodating the subject 110 in a direction orthogonal to a body axis of the subject 110 in a case of a vertical magnetic field method, or in a direction of the body axis of the subject 110 in a case of a horizontal magnetic field method. The static magnetic field generation source 120 of a permanent magnet method, an electromagnet method, or a superconducting method is disposed in the vicinity of the subject 110.

The gradient magnetic field generation unit 130 includes gradient magnetic field coils 131 that generate gradient magnetic fields in three axial directions of X, Y, and Z, which are a coordinate system (stationary coordinate system) of the medical image capturing apparatus 100, and a gradient magnetic field power source 132 that drives each of the gradient magnetic field coils 131, in a superimposed manner in the static magnetic field space. Gradient magnetic fields Gx, Gy, and Gz are generated in the three axial directions X, Y, and Z by driving the gradient magnetic field power source 132 of each coil in response to a command, that is, control from the sequencer 140 described below. In the imaging, a slice direction gradient magnetic field pulse (Gs) is applied in a direction orthogonal to a slice plane (imaging cross section) to set the slice plane with respect to the subject 110, and a phase encoding direction gradient magnetic field pulse (Gp) and a frequency encoding direction gradient magnetic field pulse (Gf) are applied in the remaining two directions orthogonal to the slice plane and orthogonal to each other, to encode position information in each direction in an echo signal.

The sequencer 140 repeatedly applies a high-frequency magnetic field pulse (RF pulse) and a gradient magnetic field pulse in a certain pulse sequence, which is predetermined. The sequencer 140 operates based on the control of a central processing unit 171 (CPU) and transmits various commands, that is, controls required for data collection of the tomographic image of the subject 110 to the gradient magnetic field generation unit 130, the high-frequency irradiation unit 150, and the signal detection unit 160.

The high-frequency irradiation unit 150 irradiates the subject 110 with the RF pulse in order to cause nuclear magnetic resonance in the atomic nucleus spin of the atom constituting the biological tissue of the subject 110. The high-frequency irradiation unit 150 includes the high-frequency oscillator 151, the modulator 152, the high-frequency amplifier 153, and an irradiation coil 154 which is a high-frequency coil on the transmission side. The subject 110 is irradiated with the electromagnetic waves by amplitude-modulating the RF pulse output from the high-frequency oscillator 151 via the modulator 152 at a timing based on the command from the sequencer 140, amplifying the amplitude-modulated RF pulse via the high-frequency amplifier 153, and then supplying the amplified RF pulse to the irradiation coil 154 disposed near the subject 110.

The signal detection unit 160 detects the echo signal, which is an NMR signal released by the nuclear magnetic resonance of the nuclear spin constituting the biological tissue of the subject 110. The signal detection unit 160 includes a reception coil 161, which is a high-frequency coil on a reception side, the signal amplifier 162, the quadrature phase detector 163, and the analog/digital converter (A/D converter) 164. The NMR signal of the response induced in the subject 110 by the electromagnetic waves applied from the irradiation coil 154 is detected by the reception coil 161 disposed near the subject 110, amplified by the signal amplifier 162, and then divided into signals of two systems orthogonal to each other by the quadrature phase detector 163 at the timing of the command from the sequencer 140, and each of the signals is converted into a digital amount by the A/D converter 164 and is transmitted to the controller 170.

The controller 170 performs various types of data processing, and displays and stores the processing results. The controller 170 includes a processor such as the CPU 171, a storage device such as an internal memory 172, an external storage device 180 such as an optical disk 181 and a magnetic disk 182, and an input/output unit 190. In a case in which the signal detection unit 160 receives the signal or the data, the CPU 171 executes processing such as signal processing and image reconstruction by using the internal memory 172 as a work area, displays the tomographic image of the subject 110, which is the result thereof, on an output device 200, and records the tomographic image in the external storage device 180.

The input/output unit 190 performs input and output of various types of control information of the medical image capturing apparatus 100 and control information of the processing performed by the controller 170, specifically, performs input reception and display of imaging parameters of the pulse sequence and the like. The input/output unit 190 consists of, for example, an input device 210 including a pointing device 211 such as a trackball, a mouse, a pad, or a touch panel, and a keyboard 212, and an output device 200 including a display 201 such as a cathode-ray tube (CRT) or a liquid crystal display (LCD), and a printer 202. The input device 210 may be disposed near the output device 200, and may be interactively controlled, for example, by an operator while viewing the display 201 to give an instruction to execute various types of processing on the medical image capturing apparatus 100 via the pointing device 211. In addition, the touch panel that operates as the input device 210 may be disposed on a display surface of the display 201, and the input operation may be performed by selecting or operating the display content of the display 201.

The subject 110 is placed on a top plate 310 of the examination table device 300 and is accommodated in the static magnetic field space, which is the imaging space, by an examination table movement device 220. The irradiation coil 154 on the transmission side and the gradient magnetic field coil 131 are installed in the static magnetic field space in which the subject 110 is accommodated, to face the subject 110 in a case of the vertical magnetic field method and to surround the subject 110 in a case of the horizontal magnetic field method. The reception coil 161 on the reception side is installed to face the subject 110 or to surround the subject 110.

It should be noted that, as the imaging target nuclide of the current MRI apparatus, a hydrogen atom nucleus (proton), which is the main constituent substance of the subject 110, is widely used in clinical practice. By visualizing information on a spatial distribution of a proton density or a spatial distribution of a relaxation time of an excited state, a morphology or a function of a human body, such as a head, an abdomen, and limbs, is imaged two-dimensionally or three-dimensionally.

Configuration of examination table device

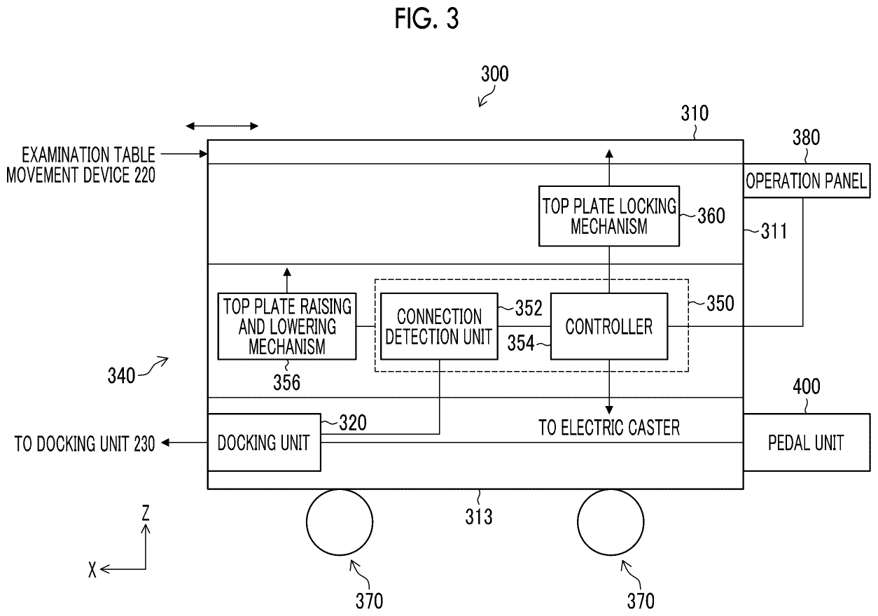

Hereinafter, the examination table device 300 will be described. FIG. 3 is a view showing a main configuration of the examination table device 300. As shown in FIG. 3, the examination table device 300 includes the top plate 310 on which the subject 110 is placed, a top plate holding unit 311, a body part 340, and a carriage 313 (traveling unit), and is configured separately from the medical image capturing apparatus 100. The body part 340 can travel via an electric caster 370 (traveling unit, caster) provided on the carriage 313. The examination table device 300 comprises, for example, four electric casters 370, but the number of the electric casters 370 may be different from this. It should be noted that, in the present embodiment, the electric caster 370 need only be a caster that can be locked by electric power, and may be a caster that does not incorporate a motor and has only a function of being locked by electric power, or may be a caster that incorporates a motor and can be self-propelled (in this case, the rotation of the motor can be locked by electric power to make the caster unable to travel).

The top plate 310 is held by the top plate holding unit 311 and can be slid in an X direction of FIG. 3 by the examination table movement device 220 in the medical image capturing apparatus 100. A top plate raising and lowering mechanism 356 includes a pantograph arm, a hydraulic jack, or the like (not shown), and raises and lowers the top plate 310 and the top plate holding unit 311 in a Z direction (vertical direction). A top plate locking mechanism 360 locks the top plate 310 to make the top plate 310 unable to slide, or release the locking of the top plate 310 to make the top plate 310 slidable.

In addition, the pedal unit 400 (connection operation member) is provided on the carriage 313, and the user of the examination table device 300 operates the pedal unit 400, so that a docking unit 320 (connection connector unit) on the examination table device 300 side and a docking unit 230 on the medical image capturing apparatus 100 side are mechanically and electrically connected to each other in an attachable and detachable manner. A processor 350 comprises a connection detection unit 352 (connection detection unit) and a controller 354 (controller), and the connection detection unit 352 detects the presence or absence of the connection between the docking unit 320 and the docking unit 230. The controller 354 controls the locking state of the top plate 310 via the top plate locking mechanism 360, and controls the travelable state of the electric caster 370 (traveling unit) based on the detected presence or absence of the connection.

It should be noted that the processor 350 is configured by various processors, such as a CPU, and an internal memory. The examination table device 300 comprises a battery (not shown) that supplies power to each unit. The battery can be charged by the power source on the medical image capturing apparatus 100 side while the examination table device 300 is connected to the medical image capturing apparatus 100.

An operation panel 380 (panel) can display one or more of the connection state, the locking state of the electric caster 370 (traveling unit, caster), or the locking state of the top plate 310, as will be described in detail below. In addition, the operation panel 380 comprises a locking operation member that receives a locking operation for giving an instruction to lock the electric caster 370 in a case in which the examination table device 300 is not connected to the medical image capturing apparatus 100, and a locking release operation to give an instruction to release the locking via the locking operation.

### Work of User and Operation of System

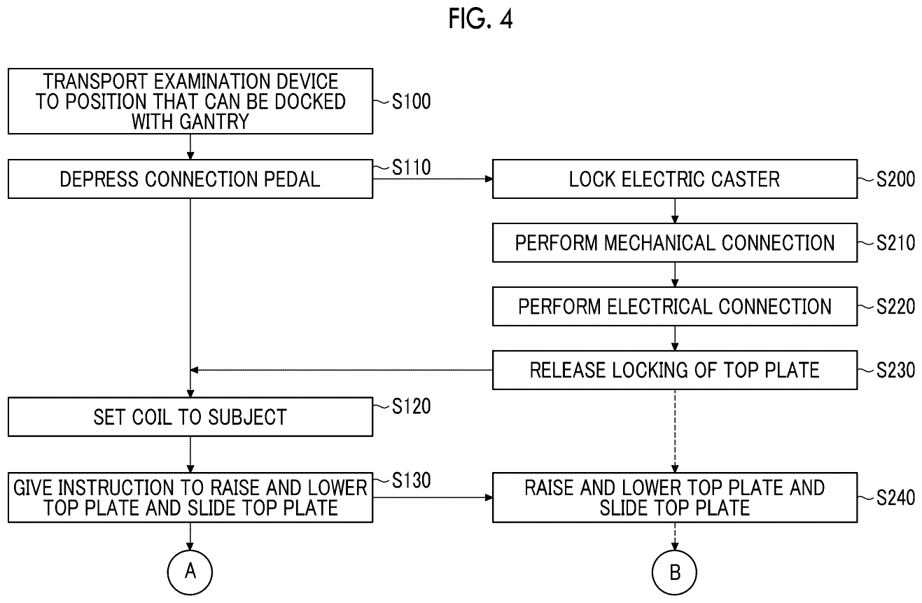

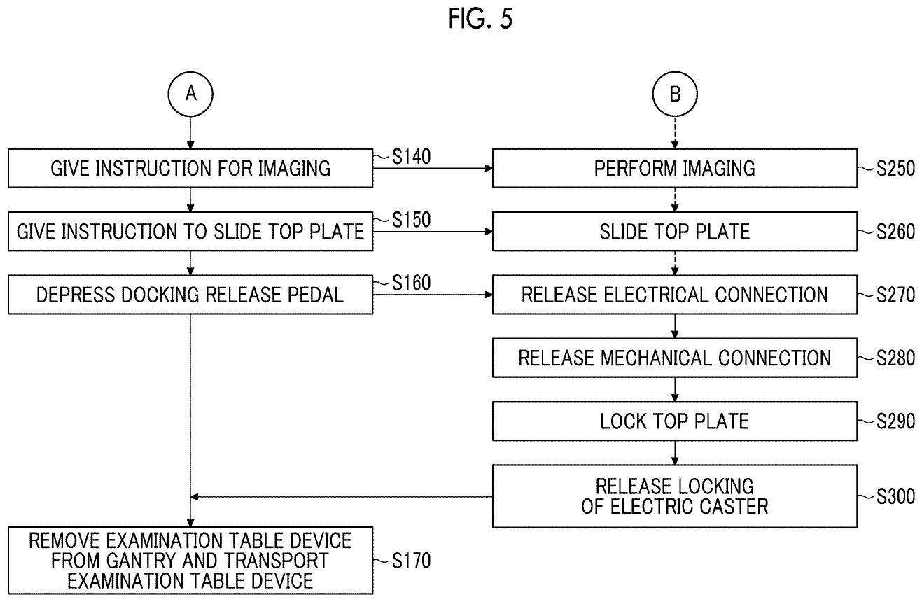

Hereinafter, a work process of the user in the medical image capturing system 10 and the operation of the system in accordance with the work process will be described with reference to FIGS. 4 and 5. It should be noted that, in FIG. 4 and FIG. 5, steps S100 to S170 indicate the work or the operation of the user, and steps S200 to S300 indicate the operation of the system. Connection between medical image capturing apparatus and examination table device

As shown in FIGS. 1A, 1B, and 3, the examination table device 300 is movable via the carriage 313 (traveling unit) to which the electric caster 370 is attached, and the subject 110 is placed on the top plate 310. In addition, as shown in FIGS. 1A, 1B, and 3, the examination table device 300 is attachable to and detachable from the apparatus body 101. The examination table device 300 separated from the apparatus body 101 is moved to a front room in which the magnetic force of the apparatus body 101 does not reach, a sickroom of the subject 110, or the like, and the subject 110 is placed on the examination table device 300. Then, the examination table device 300 is moved to a position at which the examination table device 300 can be docked with the gantry (apparatus body 101) in a state in which the subject 110 is placed on the examination table device 300 (step S100). The user depresses a connection pedal 410 (step S110) to connect the examination table device 300 to the apparatus body 101 (steps S200 to S230). In a case of the connection, the locking of the electric caster 370 and the locking release of the top plate 310 are performed (steps S200 and S230). Details of the connection and the control of the locking state, and the configuration for performing the controls will be described below.

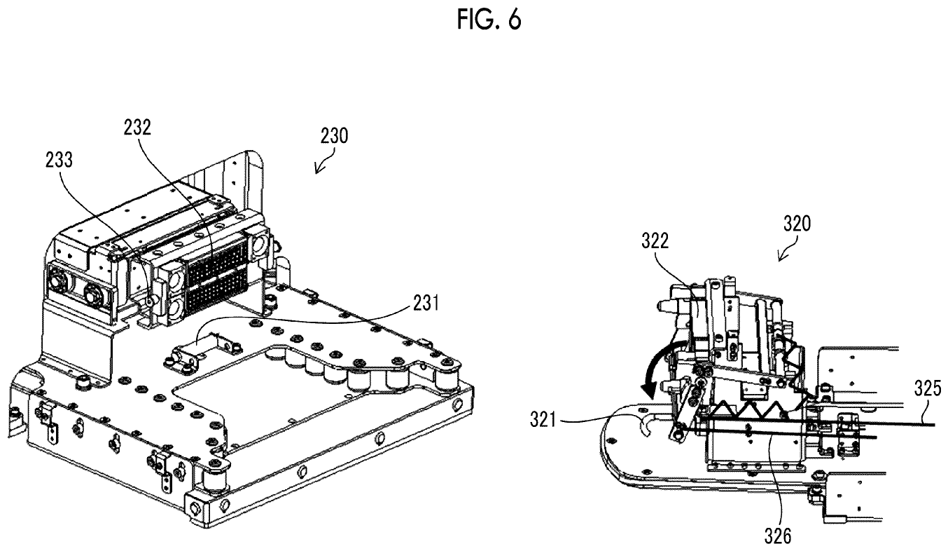

As shown in FIGS. 1A, 1B, 3, and 6, as a unit for the connection between the apparatus body 101 and the examination table device 300, the docking unit 230 is provided on a front surface of the apparatus body 101, the docking unit 320 is installed on a distal end side (+X side) of the carriage 313 of the examination table device 300, and the pedal unit 400 is installed on a rear end side (−X side). It should be noted that, in a case in which a cover 315 of the examination table device 300 is removed, the docking unit 320 and the pedal unit 400 appear (see FIGS. 1A and 1B). The docking unit 320 and the pedal unit 400 are connected to each other through a wire 325 for the mechanical connection and a wire 326 for the electrical connection. The operation on the pedal unit 400 is transmitted to the docking unit 320 through the wire 325 and the wire 326, and the docking unit 320 is mechanically and electrically coupled (docked, connected) to the docking unit 230 (see FIGS. 1A, 1B, and 6).

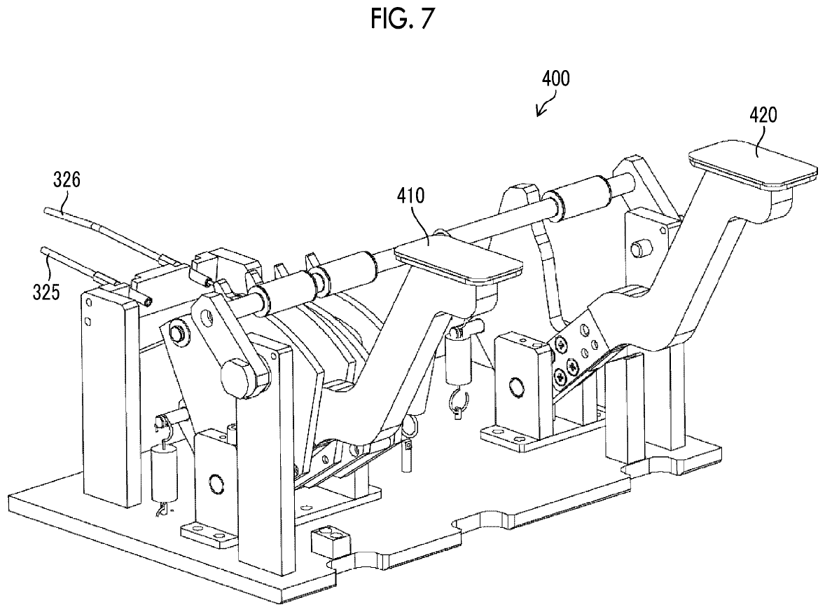

FIG. 7 is a view showing a configuration of the pedal unit. As shown in FIG. 7, the pedal unit 400 comprises two pedals, that is, the connection pedal 410 and a connection release pedal 420. In general, lower end sides of the connection pedal 410 and the connection release pedal 420 are hidden by the cover 315 shown in FIG. 1B, and only upper end sides thereof are exposed. The connection pedal 410 is a pedal for sequentially performing the operations of both the mechanical connection and the electrical connection between the apparatus body 101 and the examination table device 300. The connection release pedal 420 is a pedal for performing the operations of the releases of the mechanical connection and the electrical connection between the apparatus body 101 and the examination table device 300. It should be noted that the pedal unit 400 further comprises a locking plate, a locking bar, a release plate, and the like (not shown) in addition to the above-described elements.

### Operation Panel

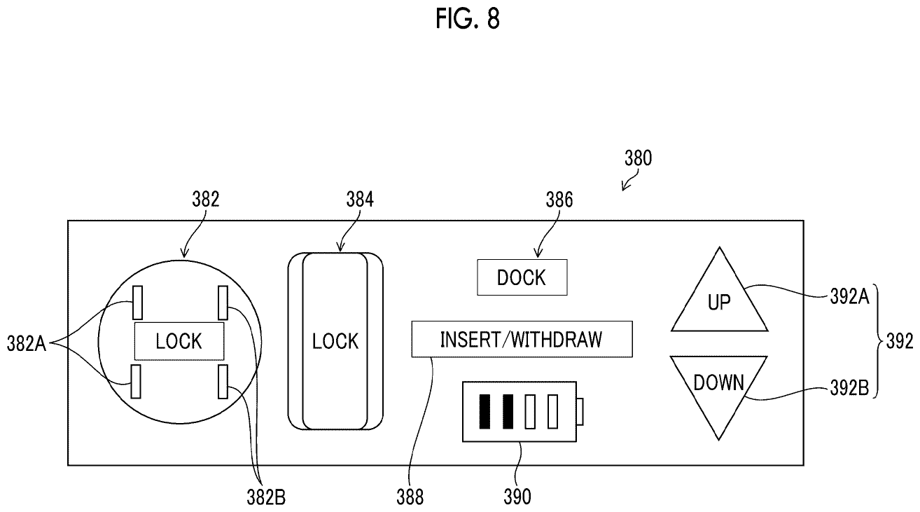

FIG. 8 is a view showing the operation panel 380 (panel) provided in the examination table device 300. The operation panel 380 is disposed in, for example, a handle portion provided at a rear portion (−X side) of the top plate holding unit 311, and comprises buttons 382, 384, 388, and 392, a lamp 386, and an indicator 390. The button 382 (locking operation member) is a button (switch) for receiving the locking operation and the locking release operation of the electric caster 370, and the user can operate the button 382 to perform the locking and the release of the locking of the electric caster 370 in any place such as a hospital corridor (in a case in which the examination table device 300 is not connected to the medical image capturing apparatus 100). The button 382 comprises a lamp 382A indicating the locking state of each wheel of the electric caster 370, and the lamp 382A emits light in different states depending on the locking state of each wheel. The button 384 is a button for the user to perform the locking and locking release operations of the top plate 310, and also emits light in different states depending on the locking state of the top plate. The lamp 386 is a lamp that displays the connection state, and emits light in a case in which the position of the examination table device 300 that can be docked (connected) with the apparatus body 101 is approached, and emits light in a different state in a case in which the docking is completed. The button 388 is a button for the user to perform operations of inserting the top plate 310 into the imaging space of the medical image capturing apparatus 100 and withdrawing the top plate 310 from the imaging space. The insertion and the withdrawing are performed by the examination table movement device 220. The lamp 386 is a lamp that indicates a remaining amount of the battery (not shown) mounted on the examination table device 300, and emits light in different states depending on the remaining amount of the battery. The button 392 includes an UP button 392A and a DOWN button 392B, and the user can operate these buttons to raise and lower the top plate 310.

### Connection Between Examination Table Device and Apparatus Body

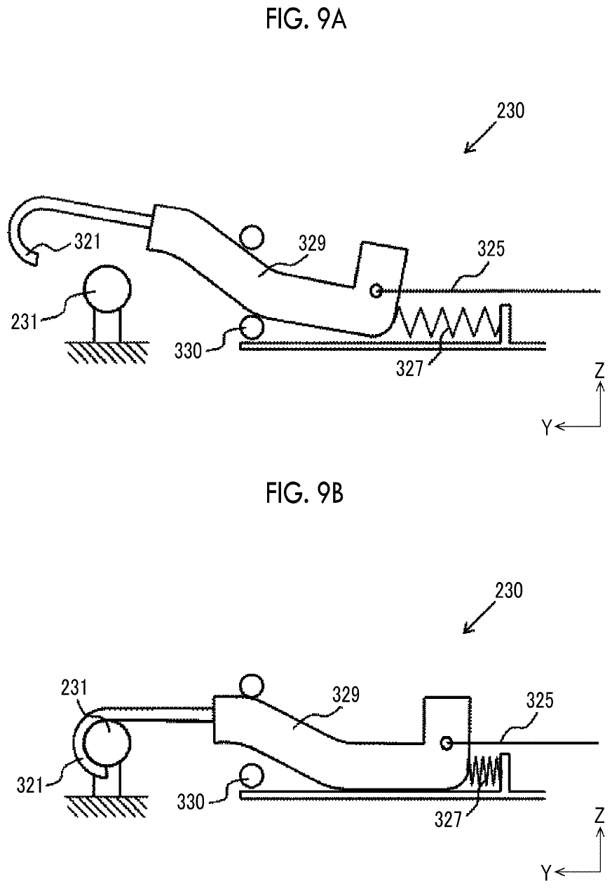

The apparatus body 101 and the examination table device 300 are mechanically connected to each other by hanging a hook 321 provided in the docking unit 320 on a coupling bar 231 provided in the docking unit 230 (step S210). Specifically, as shown in FIGS. 9A and 9B, in a case in which the user depresses the connection pedal 410, the wire 325 is pulled, a rear side of a support portion 329 is lowered from a protrusion 330, the hook 321 also is lowered downward, and a distal end of the hook 321 is hooked on the coupling bar 231 (transition from the state shown in FIG. 9A to the state shown in FIG. 9B; mechanical connection).

In addition, an electrical connector 322 provided in the docking unit 320 is fitted into an electrical connector 232 provided in the docking unit 230, whereby the apparatus body 101 and the examination table device 300 are electrically connected to each other (step S220). Specifically, in a case in which the user further depresses the connection pedal 410, the wire 326 shown in FIG. 6 is pulled, a coupling tool rotates downward about the axis, and a pin 233 enters the notch. As a result, the registration between the electrical connectors is performed, and the electrical connectors are attracted to and connected to each other (electrically connected) as they are. As described above, in the examination table device 300 according to the first embodiment, the mechanical and electrical connections can be performed by operating the connection pedal 410.

### Operation Accompanying Connection: Locking of Electric Caster and Locking Release of Top Plate

In a case in which the user depresses the connection pedal 410, the locking of the electric caster 370 (step S200; locking of the traveling unit) and the locking release of the top plate 310 (step S230) are performed in conjunction with the connection between the apparatus body 101 and the examination table device 300. The locking of the electric caster 370 can be performed, for example, by stopping the rotation of the electric caster 370 by meshing gears with each other via electric power, but may be performed by stopping the rotation by inserting the pin into the caster portion as in the locking of the top plate 310 described below. In the medical image capturing system 10 according to the first embodiment, since the electric caster 370 (traveling unit, caster) is locked by electric power in conjunction with the connection in this manner, the user never forgets to operate the locking pedal and lock the electric caster 370. Locking of top plate

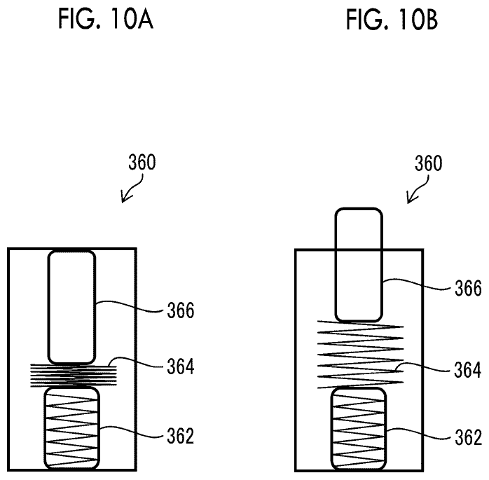

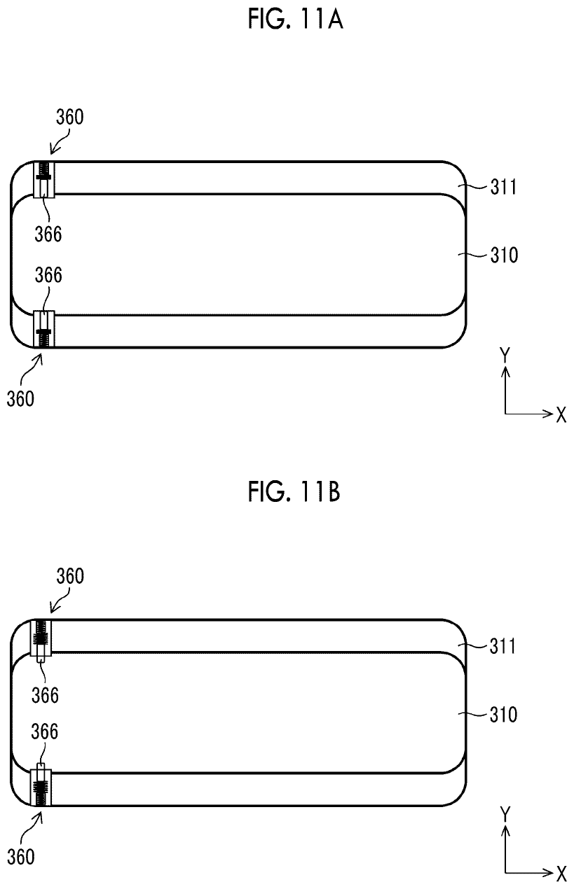

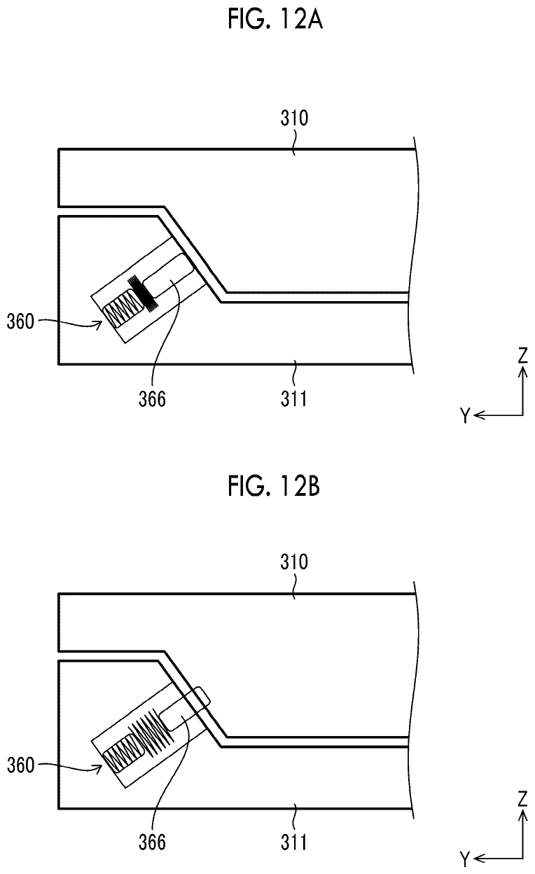

FIGS. 10A and 10B are views showing a configuration of the top plate locking mechanism 360. As shown in FIGS. 10A and 10B, the top plate locking mechanism 360 comprises a solenoid coil 362 (second solenoid coil, electromagnetic coil), a spring 364 (second spring member) that is compressed by energizing the solenoid coil 362, and a locking pin 366 (locking pin) connected to the spring 364, and the top plate locking mechanism 360 is disposed on the −X side (+Y side and −Y side) of the top plate holding unit 311 as shown in FIGS. 11A and 11B. In this way, it is preferable that the top plate locking mechanism 360 is provided on the rear portion (−X side) of the top plate 310 so as not to enter the magnetic field of the medical image capturing apparatus 100. FIGS. 12A and 12B are partial cross-sectional views showing the disposition of the top plate locking mechanism 360 in the top plate holding unit 311.

In a state in which the apparatus body 101 and the examination table device 300 are not connected to each other, as shown in FIG. 10B, energizing the solenoid coil 362 is turned off, and the compression of the spring 364 is stopped, and the locking pin 366 protrudes. FIG. 11B and FIG. 12B show a state in which the locking pin 366 protrudes and is inserted into the top plate 310 (locking state of the top plate 310).

In a case in which the connection detection unit 352 (processor 350) detects the connection between the apparatus body 101 and the examination table device 300, the controller 354 (processor 350) energizes the solenoid coil 362 to compress the spring 364, and removes the locking pin 366 from the top plate 310 as shown in FIG. 10A. FIG. 11A and FIG. 12A show a state in which the locking pin 366 is removed from the top plate 310 (locking release state of the top plate 310). In this state, the top plate 310 can be slid by the examination table movement device 220. In the medical image capturing system 10 according to the first embodiment, since the locking of the top plate 310 is released in conjunction with the connection in this manner, the top plate 310 cannot be slid due to the locking release not being in time. It should be noted that the controller 354 may first perform one of the locking of the electric caster 370 or the release of the locking of the top plate 310, or may perform both in parallel.

### Raising and Lowering, and Sliding of Top Plate

The user sets the coil to the subject (step S120), and operates the operation panel 380 or operates the input device 210 of the medical image capturing apparatus 100 or an operation member (not shown) to give an instruction to raise, lower, and slide the top plate 310 (step S130). In response to this instruction, the top plate raising and lowering mechanism 356 raises the top plate 310 and the top plate holding unit 311 to the height of the imaging space of the apparatus body 101 (step S240), and the examination table movement device 220 slides the top plate 310 in the horizontal direction (+X direction in FIG. 3) with respect to the top plate holding unit 311 (step S240). As a result, the subject 110 is inserted into the imaging space, and an imaging part of the subject 110 can be transported to an imaging position.

### Imaging

In a case in which the imaging part of the subject 110 is transported to the imaging position, the user gives an instruction to perform the imaging by operating the input device 210 or the like (step S140), and the imaging is performed in a predetermined sequence in response to the instruction (step S250).

### Sliding of Top Plate

After the imaging ends, the user operates the operation panel 380 or operates the input device 210 of the medical image capturing apparatus 100 or an operation member (not shown) to give an instruction to slide the top plate 310 (step S150), and the examination table movement device 220 slides the top plate 310 in the −X direction to return the top plate 310 to the original position in response to the instruction (step S160). In a case in which the top plate 310 is raised and lowered during the connection, the top plate raising and lowering mechanism 356 returns the top plate 310 to the original height.

### Release of Connection

As an examiner (user) depresses the connection release pedal 420 (release pedal) (step S160), the release plate, the locking bar, the locking plate, and the like (not shown) operate, and the wire 326 is pulled. As a result, first, the pin 233 is pushed out from the notch of the coupling tool, and the docking between the electrical connector 232 and the electrical connector 322 is released (step S270: release of the electrical connection). Then, by further depressing the connection release pedal 420 (step S160), the support portion 329 is pushed forward and rides on the protrusion 330, so that the hook 321 is raised to the original position and is removed from the coupling bar 231 (step S280: release of mechanical connection, transition from the state shown in FIG. 9B to the state shown in FIG. 9A). As described above, in the examination table device 300, the electrical and mechanical connections can be released by operating the connection release pedal 420, which is a single operation member.

### Operation Accompanying Connection Release

In a case in which the connection detection unit 352 (processor 350) detects the release of the connection, the controller 354 (processor 350) releases the locking of the electric caster 370 (traveling unit) (step S300) in response to this detection to make the examination table device 300 travelable, and locks the top plate 310 (step S290) to make the top plate 310 unable to slide. The controller 354 can release the locking of the electric caster 370, for example, by releasing the engagement of the gears described above. In addition, the controller 354 can stop compressing the spring 364 by stopping energizing the solenoid coil 362, and can cause the locking pin 366 to protrude and insert the locking pin 366 into the top plate 310, thereby locking the top plate 310. It should be noted that the controller 354 may first perform one of the release of the locking of the electric caster 370 or the locking of the top plate 310, or may perform both in parallel. In a case in which the release of the locking of the electric caster 370 and the locking of the top plate 310 are performed, the user removes the examination table device 300 from the gantry (apparatus body 101) and transports the examination table device 300 (step S170).

### Effects of First Embodiment

As described above, with the medical image capturing system 10 (medical image capturing apparatus 100, examination table device 300) according to the first embodiment, since the locking state of the electric caster 370 and the locking state of the top plate 310 are controlled in conjunction with the connection between the medical image capturing apparatus 100 and the examination table device 300, the locking states of the electric caster 370 (traveling unit, caster) and the top plate 310 can be reliably controlled.

### Modification Example

### Modification Example of Locking of Traveling Unit

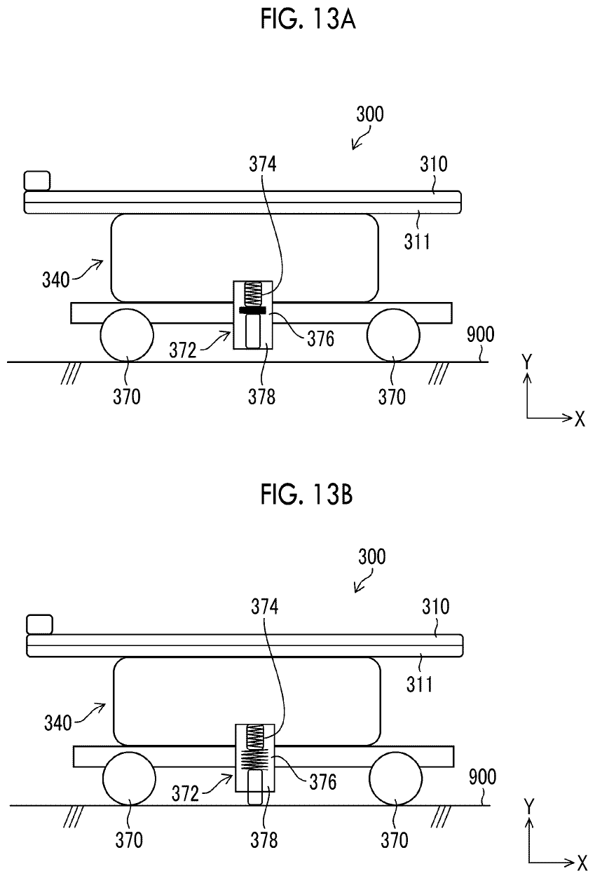

FIGS. 13A and 13B are views showing a modification example of the configuration of locking the traveling unit. In the modification example shown in FIGS. 13A and 13B, the examination table device 300 comprises a traveling unit locking mechanism 372 similar to the top plate locking mechanism 360. The traveling unit locking mechanism 372 comprises a solenoid coil 374 (first solenoid coil), a spring 376 (first spring member) that is compressed by energizing the solenoid coil 374, and a stopper 378 (stopper) that is connected to the spring 376 and that can protrude from the body part 340 toward a traveling surface 900. An elastic member such as rubber may be provided, as an anti-slip, on a distal end portion (side in contact with the traveling surface 900) of the stopper 378.

In a case in which the user gives the instruction to release the locking of the traveling unit on the operation panel 380 in a state in which the examination table device 300 is not connected to the apparatus body 101 (medical image capturing apparatus 100), as shown in FIG. 13A, the controller 354 (processor 350) compresses the spring 376 by energizing the solenoid coil 374, and separates the stopper 378 from the traveling surface 900 (traveling surface), thereby releasing the locking of the traveling unit and making the body part 340 (examination table device 300) travelable. In a case in which the examination table device 300 is connected to the apparatus body 101, and in a case in which the examination table device 300 is not connected to the apparatus body 101 but the user has given the instruction to lock the traveling unit on the operation panel 380, as shown in FIG. 13B, the controller 354 stops compressing the spring 376 by stopping energizing the solenoid coil 374, and causes the stopper 378 to protrude and abut on (touch, be connected to) the traveling surface, thereby locking the traveling unit and making the body part 340 unable to travel.

One or a plurality of the traveling unit locking mechanisms 372 may be provided. By increasing the number of the traveling unit locking mechanisms 372 and/or increasing the abutting force, it is possible to reliably prevent unintended traveling of the traveling unit.

### Modification Example of Top Plate Locking Mechanism

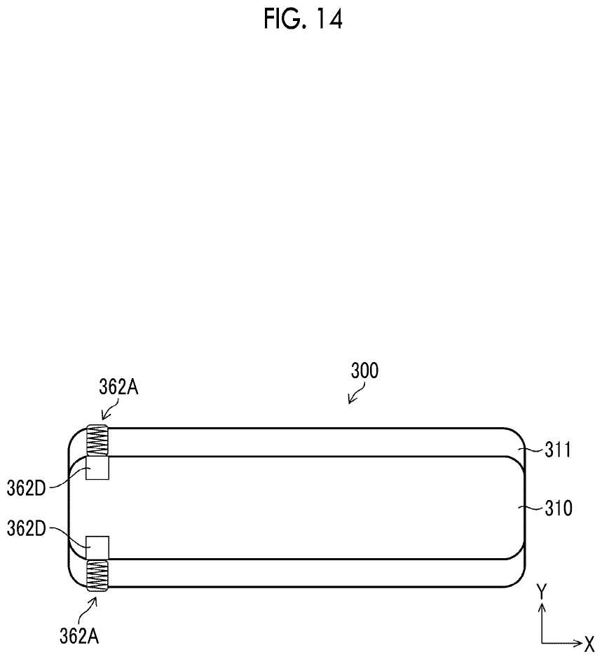

FIG. 14 is a view showing a modification example of the top plate locking mechanism (top view of the examination table device 300). In the modification example shown in FIG. 14, in the examination table device 300, a solenoid coil 362A (third solenoid coil) is provided in the top plate holding unit 311, and a magnetic material 362D (magnetic material) is disposed on the top plate 310 at a position facing the solenoid coil 362A. In a case of locking the top plate 310, the controller 354 (processor 350) energizes the solenoid coil 362A to attract the magnetic material 362D with magnetic force, thereby locking the top plate 310. In a case in which the locking of the top plate 310 is released, the controller 354 stops energizing the solenoid coil 362A to stop the attraction. In such a configuration, since the member does not have a mechanical operation, the influence of abrasion or assembly error can be reduced. It should be noted that it is preferable that such a top plate locking mechanism is provided on the rear portion (−X side) of the top plate 310 so as not to enter the magnetic field of the medical image capturing apparatus 100.

### Others

In the examination table device 300 according to the present embodiment, the hardware structure of the processor 350 (connection detection unit 352 and controller 354) that executes the connection detection, the control of the locking states of the top plate 310 and the traveling unit, and the like is, for example, various processors as follows. The “various processors” include, for example, a central processing unit (CPU) which is a general-purpose processor executing software (program) to function as various processing units, a programmable logic device (PLD), such as a field programmable gate array (FPGA), which is a processor whose circuit configuration can be changed after manufacture, and a dedicated electric circuit, such as an application specific integrated circuit (ASIC), which is a processor having a dedicated circuit configuration designed to perform specific processing.

The connection detection unit 352 and the controller 354 may be configured by one of these various processors or by two or more processors of the same type or different types (for example, a plurality of FPGAs or a combination of a CPU and an FPGA). A plurality of processing units (connection detection unit 352 and the controller 354) may be configured by one processor. A first example of the configuration in which a plurality of processing units are configured by one processor is a form in which one processor is configured by a combination of one or more CPUs and software, and this processor functions as a plurality of processing units, as represented by a client computer or a server computer. A second example of the configuration is a form in which a processor that implements the functions of the entire system including a plurality of processing units using one integrated circuit (IC) chip is used, as represented by a system on a chip (SoC). As described above, various processing units can be configured by using one or more of the various processors as the hardware structure.

More specifically, the hardware structure of these various processors is an electric circuit (circuitry) obtained by combining circuit elements such as semiconductor elements. It should be noted that, in a case in which the various processors operate, a program or data recorded on a non-transitory and tangible recording medium, such as a read only memory (ROM), can be referred to, and a recording medium, such as a random access memory (RAM), or an internal memory can be used as a transitory work area during the operation.

Further, it is needless to say that the present invention is not limited to the above-described embodiments and can be variously modified.

### EXPLANATION OF REFERENCES

220: examination table movement device
230: docking unit
300: examination table device
310: top plate
311: top plate holding unit
313: carriage
320: docking unit
340: body part
350: processor
352: connection detection unit
354: controller
356: top plate raising and lowering mechanism
360: top plate locking mechanism
370: electric caster
380: operation panel
400: pedal unit

What is claimed is:

1. An examination table device comprising:
a body part including a top plate on which a subject is placed;
a traveling unit that causes the body part to travel;
a connection connector unit that mechanically and electrically connects the body part to a medical image capturing apparatus configured separately from the body part, in an attachable and detachable manner;
a connection operation member that receives operations of giving instructions to perform the connection and a release of the connection;
a connection detection unit that detects presence or absence of the connection; and
a controller that controls a locking state of the top plate and a travelable state of the traveling unit based on the detected presence or absence of the connection,
wherein the controller
locks the traveling unit to make the body part unable to travel and releases locking of the top plate to make the top plate slidable in response to the detection of the connection via the connection detection unit, and
releases the locking of the traveling unit to make the body part travelable and locks the top plate to make the top plate unable to slide in response to the detection of the release of the connection via the connection detection unit.

2. The examination table device according to claim 1,
wherein the traveling unit includes a caster that is lockable via electric power, and
the controller locks the caster via the electric power to make the body part unable to travel, and releases the locking to make the body part travelable.

3. The examination table device according to claim 1,
wherein the traveling unit includes a stopper that is able to protrude toward a traveling surface from the body part, and
the controller locks the traveling unit by causing the stopper to protrude and abut on the traveling surface, and releases the locking of the traveling unit by separating the stopper from the traveling surface.

4. The examination table device according to claim 3,
wherein the traveling unit includes a first solenoid coil, a first spring member that is compressed by energizing the first solenoid coil, and the stopper connected to the first spring member, and
the controller separates the stopper from the traveling surface by energizing the first solenoid coil to compress the first spring member, and causes the stopper to protrude and abut on the traveling surface by stopping energizing the first solenoid coil to stop compressing the first spring member.

5. The examination table device according to claim 1,
wherein the body part includes a second solenoid coil, a second spring member that is compressed by energizing the second solenoid coil, and a locking pin connected to the second spring member, and
the controller removes the locking pin from the top plate by energizing the second solenoid coil to compress the second spring member, and causes the locking pin to protrude and inserts the locking pin into the top plate by stopping energizing the second solenoid coil to stop compressing the second spring member.

6. The examination table device according to claim 1,
wherein the body part includes a third solenoid coil and a magnetic material disposed on the top plate to face the third solenoid coil, and
the controller makes the top plate unable to slide by energizing the third solenoid coil to attract the magnetic material on a side of the third solenoid coil, and makes the top plate slidable by stopping energizing the third solenoid coil to release the attraction.

7. The examination table device according to claim 1,
wherein the connection operation member includes a connection pedal that receives an operation for the connection, and a connection release pedal that receives an operation for the release of the connection.

8. The examination table device according to claim 1, further comprising:
a panel that displays one or more of a state of the connection, a locking state of the traveling unit, or the locking state of the top plate.

9. The examination table device according to claim 8,
wherein the panel includes a locking operation member that receives a locking operation of giving an instruction to lock the traveling unit in a case in which the examination table device is not connected to the medical image capturing apparatus, and a locking release operation of giving an instruction to release the locking via the locking operation, and
the controller locks the traveling unit in response to the locking operation, and releases the locking of the traveling unit in response to the locking release operation.

10. A medical image capturing system comprising:
the examination table device according to claim 1; and
the medical image capturing apparatus.

11. The medical image capturing system according to claim 10,
wherein the medical image capturing apparatus includes any one of an MRI apparatus, an X-ray CT apparatus, or a PET apparatus.

12. An operation method of an examination table device including a body part including a top plate on which a subject is placed, a traveling unit that causes the body part to travel, a connection connector unit that mechanically and electrically connects the body part to a medical image capturing apparatus configured separately from the body part, in an attachable and detachable manner, a connection operation member that receives operations of giving instructions to perform the connection and a release of the connection, a connection detection unit that detects presence or absence of the connection, and a controller that controls a locking state of the top plate and a travelable state of the traveling unit based on the detected presence or absence of the connection, the operation method comprising:
via the controller,
locking the traveling unit to make the body part unable to travel and releasing locking of the top plate to make the top plate slidable in response to the detection of the connection via the connection detection unit; and
releasing the locking of the traveling unit to make the body part travelable and locking the top plate to make the top plate unable to slide in response to the detection of the release of the connection via the connection detection unit.
